(19) United States
(12) Patent Application Publication
(10) Pub. No.: US 2021/0358369 A1
(43) Pub. Date: Nov. 18, 2021

(54) DISPLAY PANEL

(71) Applicant: WUHAN CHINA STAR OPTOELECTRONICS TECHNOLOGY CO., LTD., Wuhan, Hubei (CN)

(72) Inventor: Dian ZHANG, Wuhan, Hubei (CN)

(21) Appl. No.: 16/626,342

(22) PCT Filed: Sep. 10, 2019
(86) PCT No.: PCT/CN2019/105052

§ 371 Date: Dec. 24, 2019

(30) Foreign Application Priority Data
Jun. 14, 2019 (CN) 201910514334.3

(51) Int. Cl. G09G 3/20

(52) U.S. Cl. CPC G09G 3/20; G09G 2310/0297

(57) ABSTRACT

The present disclosure provides a display panel. At least two de-multiplex control signal output lines of a de-multiplex circuit respectively output a first de-multiplex control signal and a second de-multiplex control signal. A falling edge of a scan signal of a scan driving circuit occurs earlier than a falling edge of the second de-multiplex control signal. The present disclosure can reduce interference on image displayed by a pixel unit caused by pulse signals of a capacitance formed by the de-multiplex control signal output lines and a data signal output line.

### FIELD OF INVENTION

The present disclosure relates to the field of display technology, particularly to a display panel.

### BACKGROUND OF INVENTION

Conventional medium-sized and large-sized display panels generally have control lines, de-multiplex control switches, data signal output lines, and data chips. Each of the data chips is electrically connected to a plurality of data lines through the data signal output lines and the de-multiplex control switches. The data chips are utilized to provide data driving signals to the data lines.

In addition, the above-mentioned conventional medium-sized and large-sized display panels generally have de-multiplex control signal output lines. The de-multiplex control signal output lines are electrically connected to the control lines. The de-multiplex control signal output lines are utilized to provide de-multiplexing control signals to the control line.

In practice, the present technologies have at least following problems.

The de-multiplex control signal output lines and the data signal output lines form a lateral capacitance. Pulse signals of the lateral capacitance interfere with displayed images displayed by pixel units in the display panels.

Therefore, new technical solutions are required to solve the above technical problems.

### SUMMARY OF INVENTION

The purpose of the present disclosure is providing a display panel which can reduce the interference on an image displayed by pixel units caused from pulse signals of a capacitance formed by a de-multiplex control signal output line and a data signal output line.

To solve the above-mentioned problems, the technical solutions of the present disclosure are as following.

A display panel comprising a pixel array; at least two data lines: at least two scan lines; a de-multiplex circuit; a data driving circuit electrically connected to the data lines through the de-multiplex circuit and comprising at least two data chips and at least two data signal output lines electrically connected to one of the data chips; a scan driving circuit electrically connected to the scan lines and configured to generate scan signals; wherein de-multiplex control signal output lines of the de-multiplex circuit are disposed on at least one side of an entire structure composed by the at least two data signal output lines of the data driving circuit, at least two de-multiplex control signals outputted by the de-multiplex control signal output lines comprise a first de-multiplex control signal and a second de-multiplex control signal, and a falling edge of the scan signal is earlier than a falling edge of the second de-multiplex control signal; a rising edge of the first de-multiplex control signal, the falling edge of the first de-multiplex control signal, and a rising edge of the second de-multiplex control signal correspondingly fall in a pulse period of the scan signal; the de-multiplex circuit comprises at two control lines, at least two de-multiplex control switches, and least two de-multiplex control signal output line, the control lines are electrically connected to the de-multiplex control switches, and the control lines are electrically connected to the de-multiplex control signal output line; and one of the data signal output lines is electrically connected to the at least two data lines through the at least two de-multiplex control switches, and the data chips are configured to generate data signals.

In the above-mentioned display panel, the data chip generates the first de-multiplex control signal and the second de-multiplex control signal in sequence, and the de-multiplex control signal output lines are electrically connected to the data chips.

In the above-mentioned display panel, the data chip generates the first de-multiplex control signal and the second de-multiplex control signal at the same time, and the de-multiplex control signal output lines are electrically connected to the data chips.

In the above-mentioned display panel, the display panel further comprises a de-multiplex control signal chip configured to generate the de-multiplex control signals, and the de-multiplex control signal chip is electrically connected to the at least two de-multiplex control signal output lines.

In the above-mentioned display panel, the control line is electrically connected to a first electrode of the de-multiplex switch; the data signal output line is electrically connected to a second electrode of the de-multiplex switch; and the data line is electrically connected to a third electrode of the de-multiplex switch.

A display panel comprising a pixel array; at least two data lines: at least two scan lines; a de-multiplex circuit; a data driving circuit electrically connected to the data lines through the de-multiplex circuit; a scan driving circuit electrically connected to the scan lines and configured to generate scan signals, wherein de-multiplex control signal output lines of the de-multiplex circuit are disposed on at least one side of an entire structure consisted of the at least two data signal output lines of the data driving circuit, at least two de-multiplex control signals outputted by the de-multiplex control signal output lines comprise a first de-multiplex control signal and a second de-multiplex control signal, and a falling edge of the scan signal is earlier than a falling edge of the second de-multiplex control signal.

In the above-mentioned display panel, a rising edge of the first de-multiplex control signal, the falling edge of the first de-multiplex control signal, and a rising edge of the second de-multiplex control signal correspondingly fall in a pulse period of the scan signal.

In the above-mentioned display panel, the de-multiplex circuit comprises at two control lines, at least two de-multiplex control switches, and least two de-multiplex control signal output lines, the control lines are electrically connected to the de-multiplex control switches, and the control lines are electrically connected to the de-multiplex control signal output line; and the data driving circuit comprises at two data chips and at least two data signal output lines electrically connected to one of the data chips, one of the data signal output line one of the data signal output lines is electrically connected to the at least two data lines through the at least two de-multiplex control switches, and the data chips are configured to generate data signals.

In the above-mentioned display panel, the data chip generates the first de-multiplex control signal and the second de-multiplex control signal in sequence, and the de-multiplex control signal output lines are electrically connected to the data chips.

In the above-mentioned display panel, the data chip generates the first de-multiplex control signal and the second de-multiplex control signal at the same time and the de-multiplex control signal output lines are electrically connected to the data chips.

In the above-mentioned display panel, the display panel further comprises a de-multiplex control signal chip configured to generate the de-multiplex control signals, and the de-multiplex control signal chip are electrically connected to the at least two de-multiplex control signal output lines.

In the above-mentioned display panel, two groups of the de-multiplex control signal output lines are electrically connected to the de-multiplex control chip and the two control lines, and the two groups of the de-multiplex control signal output lines are laterally disposed on two sides of an entire structure consisted of the at least two data signal output lines.

In the above-mentioned display panel, the de-multiplex control chip generates the first de-multiplex control signal and the second de-multiplex control signal in sequence, and the de-multiplex control signal output lines are electrically connected to the data chips.

In the above-mentioned display panel, the de-multiplex control chip generates the first de-multiplex control signal and the second de-multiplex control signal at the same time, and the de-multiplex control signal output lines are electrically connected to the data chips

In the above-mentioned display panel, a structure consisted of the at least two data chips and the data signal output lines electrically connected the data chips is disposed in array on one side of the pixel array.

In the above-mentioned display panel, the control line is electrically connected to a first electrode of the de-multiplex switch; the data signal output line is electrically connected to a second electrode of the de-multiplex switch; and the data line is electrically connected to a third electrode of the de-multiplex switch.

In the above-mentioned display panel, the pixel array at least comprises a first pixel array and a second pixel array; the at least two data lines comprise a first data line and a second data line, the first data line is electrically connected to a pixel unit of the first pixel array, and the second data line is electrically connected to a pixel unit of the second pixel array; the at least two data signal output lines comprise a first data signal output line and a second data signal output line; and the at least two de-multiplex control switches comprise a first de-multiplex control switch and a second de-multiplex control switch; a second electrode of the first de-multiplex control switch is electrically connected to the first data signal output line, a third electrode of the first de-multiplex control switch is electrically connected to the first data line, a second electrode of the second de-multiplex control switch is electrically connected to the second data signal output line, and a third electrode of the first de-multiplex control switch is electrically connected to the second data line.

In the above-mentioned display panel, the scan signal is utilized to control turning-on of a first thin film transistor switch in the first pixel unit electrically connected to the scan line during the process of turning on the first de-multiplex control switch so that the first data signals outputted by the first data signal output line are inputted to the first pixel unit through the first data line and the first thin-film transistor.

In the above-mentioned display panel, the scan signal is utilized to control turning-on of a second thin film transistor switch in the second pixel unit electrically connected to the scan line during the process of turning on the second de-multiplex control switch so that the second data signals outputted by the first data signal output line are inputted to the second pixel unit through the second data line and the second thin-film transistor; and the scan signal is further utilized to control turning-on of the second thin film transistor switch during the process of turning on the second de-multiplex control switch so that electric charges generated from a lateral capacitance formed by the de-multiplex control signal output and the second data signal output line are prevented from being inputted to the second pixel unit.

In the above-mentioned display panel, the scan signal is generated according to a clock signal inputted to the scan driving circuit.

In comparison with the present technologies, because the falling edge of the scan signal SCN occurs earlier than the falling edge of the second de-multiplex control signal EN2 in the present disclosure, the second thin film transistor switch of the second pixel unit 1012 is turned off in advance before the second de-multiplex control switch 1014 is turning on.

Therefore, the interference on the image displayed by the second pixel unit caused by the pulse signal of the lateral capacitance formed by the de-multiplex control signal output line and the data signal output line can be reduced.

In order to clarity the present disclosure, the preferred embodiments are described below in detail accompanying with drawings.

### DESCRIPTION OF DRAWINGS

FIG. 1 illustrates a display panel of a first embodiment of the present disclosure.

FIG. 2 illustrates connecting relationship between control lines, de-multiplex control switches, data signal output lines, and data lines of the display panel of the first embodiment of the present disclosure.

FIG. 3 illustrates waveforms of a scan signal, a first de-multiplex control signal, and a second de-multiplex control signal of the display panel of the first embodiment of the present disclosure.

FIG. 4 illustrates a display panel of a second embodiment of the present disclosure.

### DETAILED DESCRIPTION OF PREFERRED EMBODIMENTS

Terms “embodiment” refer to practical examples, illustrative examples, or an exemplification in the present specification. In addition, articles “a” or “an” can refer to “one” or “more than one” unless the articles “a” or “an” are clearly defined as single.

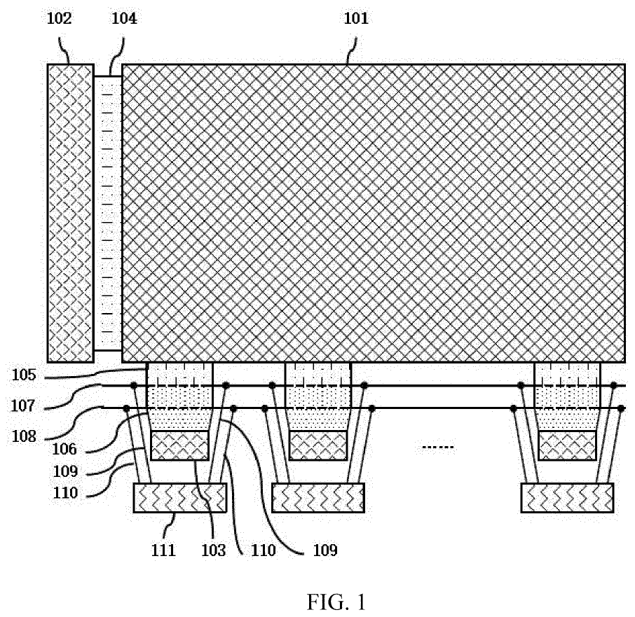

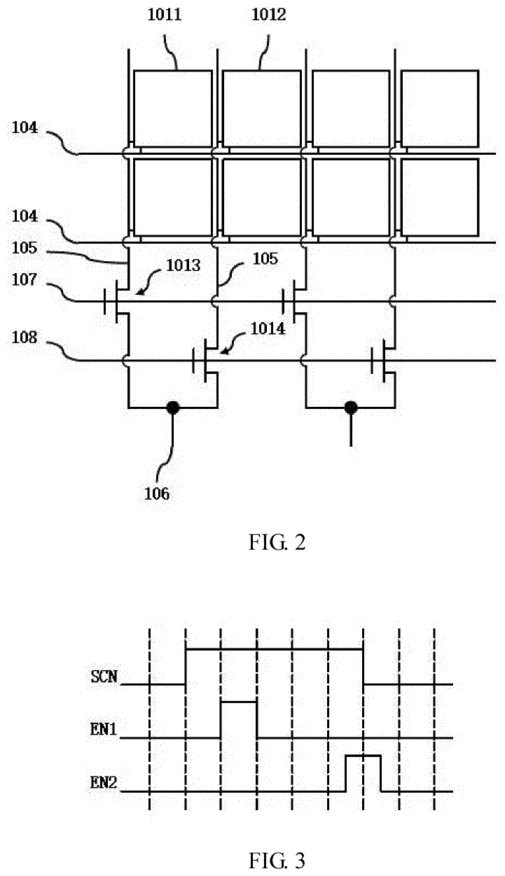

Please refer to FIG. 1, FIG. 2, and FIG. 3. FIG. 1 illustrates a schematic view of a display panel of a first embodiment of the present disclosure. FIG. 2 illustrates a connecting relationship of control lines (107, 108), de-multiplex control switches, data signal output lines 106, and data lines 105 in the first embodiment of the display panel of the present disclosure. FIG. 3 illustrates schematic waveforms of a scan signal SCN, a first de-multiplex control signal EN1, and a second de-multiplex control signal EN2 in the first embodiment of the display panel of the present disclosure.

The display panel of this embodiment may be a thin-film transistor liquid crystal display (TFT-LCD), an organic light emitting diode (OLED), etc.

The display panel of this embodiment includes a pixel array 101, a data line 105, a scan line 104, a de-multiplex circuit, a data driving circuit, and a scan driving circuit 102.

The scan lines 104 and the data lines 105 are electrically connected to pixel units in the pixel array 101. The data driving circuits are electrically connected to the data lines 105 through the de-multiplex circuits. The data driving circuit is configured to generate data signals and to output the data signals to the pixel units through the data lines 105. The scan driving circuit 102 is electrically connected to the scan lines 104. The scan driving circuit 102 is configured to generate scan signals SCN and to output the scan signals SCN to the pixel units through the scan lines 104. De-multiplex control signal output lines (109, 110) of the de-multiplex circuit are disposed on at least one side of an entire structure consisted of at least two data signal output lines 106 of the data driving circuit. At least two de-multiplexing control signals output by the at least two de-multiplex control signal output lines (109, 110) include a first de-multiplex control signal EN1 and a second de-multiplex control signal EN2.

An occurrence time of a falling edge of the scan signal SCN is earlier than an occurrence time of a falling edge of the second de-multiplex control signal EN2. The scan signal SCN is utilized to control the thin film transistors corresponding to the pixel units to be turned off in advance during the turning on of the de-multiplex control switch so that interference caused by the pulse signal on the image displayed by the pixel units is reduced.

All of an occurrence time of a rising edge of the first de-multiplex control signal EN1, an occurrence time of a falling edge of the first de-multiplex control signal EN1, and an occurrence time of a rising edge of the second de-multiplex control signal EN2 fall in the pulse duration of the scan signal SCN. That is, the occurrence time of the rising edge of the first de-multiplex control signal EN1, the occurrence time of the falling edge of the first de-multiplex control signal EN1, and the occurrence time of the rising edge of the second de-multiplex control signal EN2 are later than a occurrence time of a rising edge of the scan signal SCN. In addition, the occurrence time of the rising edge of the first de-multiplex control signal EN1, the occurrence time of the falling edge of the first de-multiplex control signal EN1, and the occurrence time of the rising edge of the second de-multiplex control signal EN2 are earlier than the occurrence time of the rising edge of the scan signal SCN

The de-multiplex circuit includes at least two control lines (107, 108), at least two de-multiplex control switches, and the at least two de-multiplex control signal output lines (109, 110). The control lines (107, 108) are electrically connected to the de-multiplex control switch. The control lines (107, 108) are electrically connected to the de-multiplex control signal output lines (109, 110). The control lines (107, 108) are configured to receive the first de-multiplex control signal EN1 and the second de-multiplex control signal EN2 through the de-multiplex control signal output lines (109, 110). The de-multiplex control switch is a triode. The control lines (107, 108) and the de-multiplex control switch are disposed between the pixel array 101 and the data driving circuit. The de-multiplex circuit is configured to de-multiplex a data signal generated by the data driving circuit. Therefore, the de-multiplex circuit is configured to de-multiplex one data signal into at least two data signals.

The data driving circuit includes at least two data chips 103 and at least two data signal output lines 106. The data signal output lines 106 are electrically connected to the data chip 103. The data signal output line 106 is electrically connected to at least two of the data lines 105 through at least two of the de-multiplex control switches. The data chips 103 are utilized to generate data signals.

The entire structure consists of at least two of the data chips 103, and the data signal output lines 106 electrically connected to the data chips 103 are arranged in an array and is on one side of the pixel array 101. Therefore, the data signal output lines 106 electrically connected to the data chips 103 and the data lines 105 can be as short as possible. As a result, attenuations of the data signals due to the impedance of the data signal output lines 106 are reduced. This helps to ensure the quality of the image displayed on the display panel.

There is a gap between two adjacent data chips 103. At least some portions of the de-multiplex control signal output lines (109, 110) are disposed at the gap between two adjacent data chips 103. As a result, the de-multiplex control signal output lines (109, 110) and the data signal output lines 106 form lateral capacitance (or form parasitic capacitance or overlapping capacitance). Therefore, when the electric currents in the de-multiplex control signal output lines (109, 110) change, a pulse signal is generated because the data signal output lines 106 are affected by the change of electric currents.

Because the scan signal SCN controls the thin film transistor switches of the pixel units to be turned off in advance, the interferences caused by the pulse signals on the image displayed by the pixel unit can be reduced.

The display panel further includes a de-multiplexing control signal chip 111. The de-multiplexing control signal chip 111 is configured to generate de-multiplexing control signals. More specifically, the de-multiplexing control signal chip 111 is configured to sequentially generate a first de-multiplex control signal EN1 and a second de-multiplex control signal EN2. That is, a waveform of the first de-multiplex control signal EN1 and a waveform of the second de-multiplex control signal EN2 appear with high voltage potential in sequence. As shown in FIG. 3, in this situation, a first de-multiplex control switch 1013 and a second de-multiplex control switch 1014 are sequentially turned on. Alternatively, the de-multiplexing control signal chip 111 is configured to simultaneously generate the first de-multiplex control signal EN1 and the second de-multiplex control signal EN2. That is, the waveform of the first de-multiplex control signal EN1 and the waveform of the second de-multiplex control signal EN2 simultaneously appear with high voltage potential. In this situation, the first de-multiplex control switch 1013 and the second de-multiplex control switch 1014 are simultaneously turned on. The de-multiplexing control signal chip 111 is electrically connected to at least two of the de-multiplex control signal output lines (109, 110).

In this embodiment, two sets of the de-multiplex control signal output lines (109, 110) are electrically connected to the de-multiplexing control signal chips 111 and the two control lines (107, 108). Each set of de-multiplex control signal output lines (109, 110) includes a first de-multiplex control signal output line 109 and a second de-multiplex control signal output line 110. The two sets of de-multiplex control signal output lines (109, 110) are respectively disposed on both sides of the entire structure of at least two of the data signal output lines 106 of the data driving circuit.

The control lines (107, 108) are electrically connected to a first electrode of the de-multiplex control switch. The data signal output line 106 is electrically connected to a second electrode of the de-multiplex control switch. The data line 105 is electrically connected to a third electrode of the de-multiplex control switch.

The control lines (107, 108) are disposed in a same layer as the scan line 104. The control lines (107, 108) and the scan line 104 are formed in a same manufacturing process. The data signal output line 106 and the data line 105 are disposed in a same layer. The data signal output line 106 and the data line 105 are formed in a same manufacturing process.

As shown in FIG. 3, the pixel array 101 includes at least a first pixel column and a second pixel column. At least two data lines 105 include a first data line and a second data line. The first data line is electrically connected to the pixel unit in the first pixel column. The second data line is electrically connected to the pixel unit in the second pixel column. At least two data signal output lines 106 include a first data signal output line and a second data signal output line. The at least two de-multiplex control switches include a first de-multiplex control switch 1013 and a second de-multiplex control switch 1014. At least two of the control lines (107, 108) include a first control line 107 and a second control line 108. The first de-multiplex control signal output line 109 is electrically connected to the first control line 107. The second de-multiplex control signal output line 110 is electrically connected to the second control line 108.

The first electrode of the first de-multiplex control switch 1013 is electrically connected to the first control line 107. The first electrode of the second de-multiplex control switch 1014 is electrically connected to the second control line 108. The second electrode of the first de-multiplex control switch 1013 is electrically connected to the first data signal output line. The third electrode of the first de-multiplex control switch 1013 is electrically connected to the first data line. The second electrode of the second de-multiplex control switch 1014 is electrically connected to the second data signal output line. The third electrode of the second de-multiplex control switch 1014 is electrically connected to the second data line.

The scan signal SCN is utilized to control the first thin film transistor switch in the first pixel unit 1011, which is electrically connected to the scan line 104, to be turned on during turning on the first de-multiplex control switch 1013, so that the data signal output by the first data signal output line is input to the first pixel unit 1011 through the first data line and the first thin film transistor switch.

The scan signal SCN is utilized to control the second thin film transistor switch in the second pixel unit 1012, which is electrically connected to the scan line 104, to be turned on during turning on the second de-multiplex control switch 1014, so that the data signal output by the second data signal output line is input to the second pixel unit 1012 through the second data line and the second thin film transistor switch.

The scan signal SCN is further configured to control the second thin film transistor switch to be turned off in advance during turning on the second de-multiplex control switch 1014. As a result, electric charge (i.e. the pulse signals) of the lateral capacitance is prevented from being inputted to the second pixel unit 1012 through the second data line and the second thin film transistor switch. The lateral capacitance is formed by the de-multiplex control signal output lines (109, 110) and the second data signal output lines.

The scan signal SCN is generated by the scan driving circuit 102 according to a clock signal inputted to the scan driving circuit 102. The clock signal is a clock signal shared by the scan driving circuit 102 and the data driving circuit. That is, the scan driving circuit 102 generates the scan signals SCN and the data driving circuit generates the data signals according to the clock signal.

The first de-multiplex control signal EN1 and the second de-multiplex control signal EN2 are respectively utilized to control the first de-multiplex control switches 1013 and the second de-multiplex control switches 1014 in the at least two de-multiplex control switches.

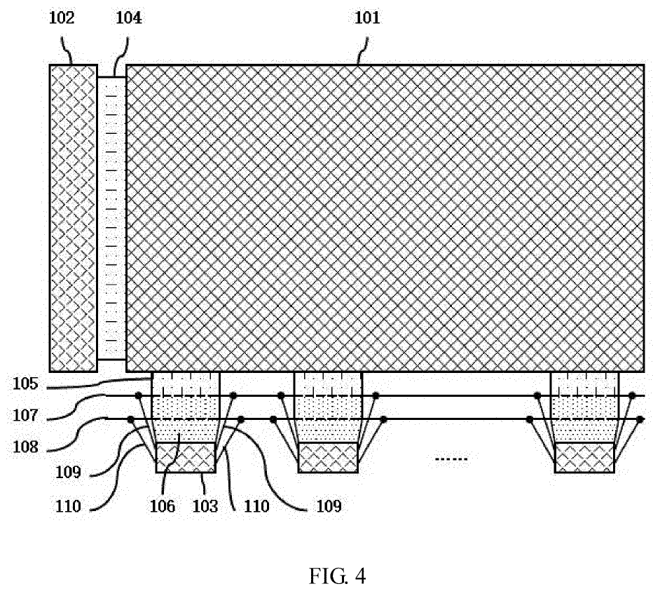

Please refer to FIG. 4, which illustrates a schematic view of a second embodiment of the display panel of the present disclosure. This embodiment is similar to the first embodiment described above, the differences are as follows.

In the first embodiment described above, the first de-multiplex control signal EN1 and the second de-multiplex control signal EN2 are generated by the de-multiplexing control signal chip 111.

In the second embodiment, the first de-multiplex control signal EN1 and the second de-multiplex control signal EN2 are generated by the data chip 103.

More specifically, the data chip 103 is further configured to sequentially generate the first de-multiplex control signal EN1 and the second de-multiplex control signal EN2. Alternatively, the data chip 103 is further configured to simultaneously generate the first de-multiplex control signal EN1 and the second de-multiplex control signal EN2.

The de-multiplex control signal output lines (109, 110) are electrically connected to the data chip 103.

In comparison with the present technologies, because the falling edge of the scan signal SCN occurs earlier than the falling edge of the second de-multiplex control signal EN2 in the present disclosure, the second thin film transistor switch of the second pixel unit 1012 is turned off in advance before the second de-multiplex control switch 1014 is turned on.

Therefore, the interference on the image displayed by the second pixel unit caused by the pulse signal of the lateral capacitance formed by the de-multiplex control signal output lines and the data signal output line can be reduced.

To conclude, although the present disclosure has disclosed preferred embodiments above, the preferred embodiments are not intended to limit the present disclosure. Variations and modifications that can be obtained by a skilled person in the art without departing from the aspect and scope of the present disclosure fall into the protected scope defined by the claims.

What is claimed is:

1. A display panel, comprising:
a pixel array;
at least two data lines:
at least two scan lines;
a de-multiplex circuit;
a data driving circuit electrically connected to the data lines through the de-multiplex circuit and comprising at least two data chips and at least two data signal output lines electrically connected to one of the data chips;
a scan driving circuit electrically connected to the scan lines and configured to generate scan signals;
wherein de-multiplex control signal output lines of the de-multiplex circuit are disposed on at least one side of an entire structure consisted of the at least two data signal output lines of the data driving circuit, at least two de-multiplex control signals outputted by the de-multiplex control signal output lines comprise a first de-multiplex control signal and a second de-multiplex control signal, and a falling edge of the scan signals is earlier than a falling edge of the second de-multiplex control signal;
a rising edge of the first de-multiplex control signal, a falling edge of the first de-multiplex control signal, and a rising edge of the second de-multiplex control signal correspondingly fall in a pulse period of the scan signals;
the de-multiplex circuit comprises at least two control lines, at least two de-multiplex control switches, and at least two de-multiplex control signal output lines, the control lines are electrically connected to the de-multiplex control switches, and the control lines are electrically connected to the de-multiplex control signal output lines; and
one of the data signal output lines is electrically connected to the at least two data lines through the at least two de-multiplex control switches, and the data chips are configured to generate data signals.

2. The display panel according to claim 1, wherein the data chips generate the first de-multiplex control signal and the second de-multiplex control signal in sequence, and the de-multiplex control signal output lines are electrically connected to the data chips.

3. The display panel according to claim 1, wherein the data chips generate the first de-multiplex control signal and the second de-multiplex control signal at a same time, and the de-multiplex control signal output lines are electrically connected to the data chips.

4. The display panel according to claim 1, further comprising:
a de-multiplex control signal chip configured to generate the de-multiplex control signals, and the de-multiplex control signal chip is electrically connected to the at least two de-multiplex control signal output lines.

5. The display panel according to claim 1, wherein the control lines are electrically connected to first electrodes of the de-multiplex control switches;
the data signal output lines are electrically connected to second electrodes of the de-multiplex control switches; and
the data lines are electrically connected to third electrodes of the de-multiplex control switches.

6. A display panel, comprising:
a pixel array;
at least two data lines:
at least two scan lines;
a de-multiplex circuit;
a data driving circuit electrically connected to the data lines through the de-multiplex circuit;
a scan driving circuit electrically connected to the scan lines and configured to generate scan signals;
wherein de-multiplex control signal output lines of the de-multiplex circuit are disposed on at least one side of an entire structure consisted of at least two data signal output lines of the data driving circuit, at least two de-multiplex control signals outputted by the de-multiplex control signal output lines comprise a first de-multiplex control signal and a second de-multiplex control signal, and a falling edge of the scan signals is earlier than a falling edge of the second de-multiplex control signal.

7. The display panel according to claim 6, wherein a rising edge of the first de-multiplex control signal, a falling edge of the first de-multiplex control signal, and a rising edge of the second de-multiplex control signal correspondingly fall in a pulse period of the scan signals.

8. The display panel according to claim 6, wherein the de-multiplex circuit comprises at least two control lines, at least two de-multiplex control switches, and at least two de-multiplex control signal output lines, the control lines are electrically connected to the de-multiplex control switches, and the control lines are electrically connected to the de-multiplex control signal output lines; and
the data driving circuit comprises at least two data chips and at least two data signal output lines electrically connected to one of the data chips, one of the data signal output lines is electrically connected to the at least two data lines through the at least two de-multiplex control switches, and the data chips are configured to generate data signals.

9. The display panel according to claim 8, wherein the data chips generate the first de-multiplex control signal and the second de-multiplex control signal in sequence, and the de-multiplex control signal output lines are electrically connected to the data chips.

10. The display panel according to claim 8, wherein the data chips generate the first de-multiplex control signal and the second de-multiplex control signal at a same time and the de-multiplex control signal output lines are electrically connected to the data chips.

11. The display panel according to claim 8, further comprising:
a de-multiplex control signal chip configured to generate the de-multiplex control signals, and the de-multiplex control signal chip is electrically connected to the at least two de-multiplex control signal output lines.

12. The display panel according to claim 8, wherein two groups of the de-multiplex control signal output lines are electrically connected to a de-multiplex control signal chip and the at least two control lines, and the two groups of the de-multiplex control signal output lines are laterally disposed on two sides of an entire structure consisted of the at least two data signal output lines.

13. The display panel according to claim 11, wherein the de-multiplex control signal chip generates a first de-multiplex control signal and a second de-multiplex control signal in sequence.

14. The display panel according to claim 11, wherein the de-multiplex control signal chip generates a first de-multiplex control signal and a second de-multiplex control signal at a same time.

15. The display panel according to claim 8, wherein an entire structure consisted of the at least two data chips and the data signal output lines electrically connected to the data chips is disposed in array on one side of the pixel array.

16. The display panel according to claim 8, wherein the control lines are electrically connected to first electrodes of the de-multiplex control switches;
the data signal output lines are electrically connected to second electrodes of the de-multiplex control switches; and
the data lines are electrically connected to third electrodes of the de-multiplex control switch.

17. The display panel according to claim 6, wherein the pixel array at least comprises a first pixel array and a second pixel array;
the at least two data lines comprise a first data line and a second data line, the first data line is electrically connected to a pixel unit of the first pixel array, and the second data line is electrically connected to a pixel unit of the second pixel array;
the at least two data signal output lines comprise a first data signal output line and a second data signal output line; and
at least two de-multiplex control switches comprise a first de-multiplex control switch and a second de-multiplex control switch, a second electrode of the first de-multiplex control switch is electrically connected to the first data signal output line, a third electrode of the first de-multiplex control switch is electrically connected to the first data line, a second electrode of the second de-multiplex control switch is electrically connected to the second data signal output line, and a third electrode of the first de-multiplex control switch is electrically connected to the second data line.

18. The display panel according to claim 17, wherein the scan signals are utilized to control turning-on of a first thin film transistor switch in a first pixel unit electrically connected to the scan lines during a process of turning on the first de-multiplex control switch so that a first data signal outputted by the first data signal output line is inputted to the first pixel unit through the first data line and the first thin-film transistor switch.

19. The display panel according to claim 17, wherein the scan signals are utilized to control turning-on of a second thin film transistor switch in a second pixel unit electrically connected to the scan lines during a process of turning on the second de-multiplex control switch so that a second data signal outputted by the first data signal output line is inputted to the second pixel unit through the second data line and the second thin-film transistor switch; and
the scan signals are further utilized to control turning-off of the second thin film transistor switch during the process of turning on the second de-multiplex control switch so that electric charges generated from a lateral capacitance formed by the de-multiplex control signal output lines and the second data signal output line are prevented from being inputted to the second pixel unit.

20. The display panel according to claim 6, wherein the scan signals are generated according to a clock signal inputted to the scan driving circuit.
